(19) United States
(12) Patent Application Publication
(10) Pub. No.: US 2009/0063137 A1
(43) Pub. Date: Mar. 5, 2009

(54) Method and Apparatus of Low-Complexity Psychoacoustic Model Applicable for Advanced Audio Coding Encoders

(76) Inventors: Tsung-Han TSAI, Jhongli City (TW); Shih-Way Huang, Jhongli City (TW); Jia-Her Luo, Jhongli City (TW)

Correspondence Address: HDLS Patent & Trademark Services, P.O. BOX 220746, CHANTILLY, VA, 20153-0746, US

(21) Appl. No.: 11/869,085

(22) Filed: Oct. 9, 2007

(30) Foreign Application Priority Data
Sep. 4, 2007 (TW) 096132907

(51) Int. Cl. G10L 19/00

(52) U.S. Cl. 704/200.1

(57) ABSTRACT

A method and an apparatus of a low-complexity psychoacoustic model applicable for advanced audio coding encoders use a modified discrete cosine transform based (MDCT-based) psychoacoustic model and a simplified look-up table to compute the MDCT-based psychoacoustic model by a logarithm based logarithmic method to simplify the computational complexity, and then computing a quantization loop (Q loop) by the logarithm based logarithmic method to further reduce the computational quantity of the MDCT-based psychoacoustic model, so as to achieve the real-time playback effect by a very low operating frequency.

### FIELD OF THE INVENTION

The present invention relates to a method and an apparatus of a low-complexity psychoacoustic model applicable for advanced audio coding encoders, and more particular to a method and an apparatus that use a low power and corrected MDCT-based psychoacoustic model and a logarithm based quantization loop (Q Loop) algorithm to achieve a real-time playback effect at a very low operating frequency by means of a low operational complexity while maintaining quality.

### BACKGROUND OF THE INVENTION

As data compression technology is an essential task for audio systems, which not only processes a huge amount of data, but also requires a high quality resolution. An audio coding compression technology, MPEG- 2/4 is an efficient audio compressing standardization which can significantly reduce the requirements of transmission bandwidth and data storage with low distortion.

Since the computational complexity of the conventional MPEG- 2/4 advanced audio coding (AAC) standard is very high, such standard cannot achieve the real-time sound playback effect, which is a bottleneck for a general handheld device (such as a mobile phone, a walkman, and a flash disk, etc), and the conventional MDCT-based psychoacoustic model performs a block-type selection on the time domain, and thus the model cannot maintain a high quality. In addition, the computational quantity of spreading function cannot be lowered and reduced.

To overcome each of the aforementioned problems, the inventor of the present invention filed a patent application to enhance a manufacturer's competitiveness in the products of this sort.

### SUMMARY OF THE INVENTION

In view of the foregoing shortcomings of the prior art MPEG- 2/4 advanced audio coding (AAC) standard that has the disadvantages of a very high computational complexity, unable to achieve a real-time sound playback effect, and being a bottleneck to the development of handheld devices, the inventor of the present invention based on years of experience in the related field to conduct extensive researches and experiments with related theories, and finally designed a method and an apparatus of a low-complexity psychoacoustic model applicable for advanced audio coding encoders in accordance with the present invention.

It is a primary objective of the present invention to provide a method and an apparatus of a low-complexity psychoacoustic model applicable for advanced audio coding encoders that use a low power and corrected MDCT-based psychoacoustic model, a simplified look-up table for a spreading function, and a logarithm based quantization loop (Q Loop) algorithm to achieve a real-time playback effect at a low operating frequency by means of a low computational complexity while maintaining quality. According to this result, the present invention includes the advantages of a high efficiency and a low complexity, and in compliance with the utility, novelty and inventive advancement of the patent application requirements. Compared with the prior art, the present invention is more applicable for a general handheld device (such as a handset, a walkman and a flash disk, etc.)

### BRIEF DESCRIPTION OF THE DRAWING

FIG. 1 is a schematic view of a corrected MDCT-based psychoacoustic model in accordance with the present invention;

FIG. 2 is a schematic view of a distribution of coefficients of a spreading function in accordance with the present invention;

FIG. 3 is a schematic view of a logarithmic corrected MDCT-based psychoacoustic model algorithm in accordance with the present invention;

FIG. 4 is a schematic view of a logarithmic quantization loop algorithm in accordance with the present invention;

FIG. 5 is a schematic view of a structure of a whole psychoacoustic model in accordance with the present invention; and

FIG. 6 is a schematic view of a structure of a threshold generator in accordance with the present invention.

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

The present invention provides a method and an apparatus of a low-complexity psychoacoustic model applicable for an advanced audio coding encoder, and the aforementioned advanced audio coding encoder refers to a MPEG- 2/4 AAC encoder, and the psychoacoustic model refers to a modified discrete cosine transform based (MDCT-based) psychoacoustic model (PAM); wherein the method of the invention comprises the following four sections:

In the first portion, a corrected MDCT-based psychoacoustic model (PAM) is used to substitute a modified discrete cosine transform (MDCT) and a filter bank used in an advanced audio coding (AAC) standard and skip the original fast Fourier transform (FFT).

In the second portion, a simplified look-up table is used for coefficients of a spreading function in the corrected MDCT-based psychoacoustic model (PAM) algorithm.

In the third portion, a logarithm based logarithmic method is used for computing the corrected MDCT-based psychoacoustic model (PAM) to reduce the computational complexity.

In the fourth portion, the operation of a logarithm based logarithmic quantization loop is used to further reduce the computational quantity of the corrected MDCT-based psychoacoustic model (PAM).

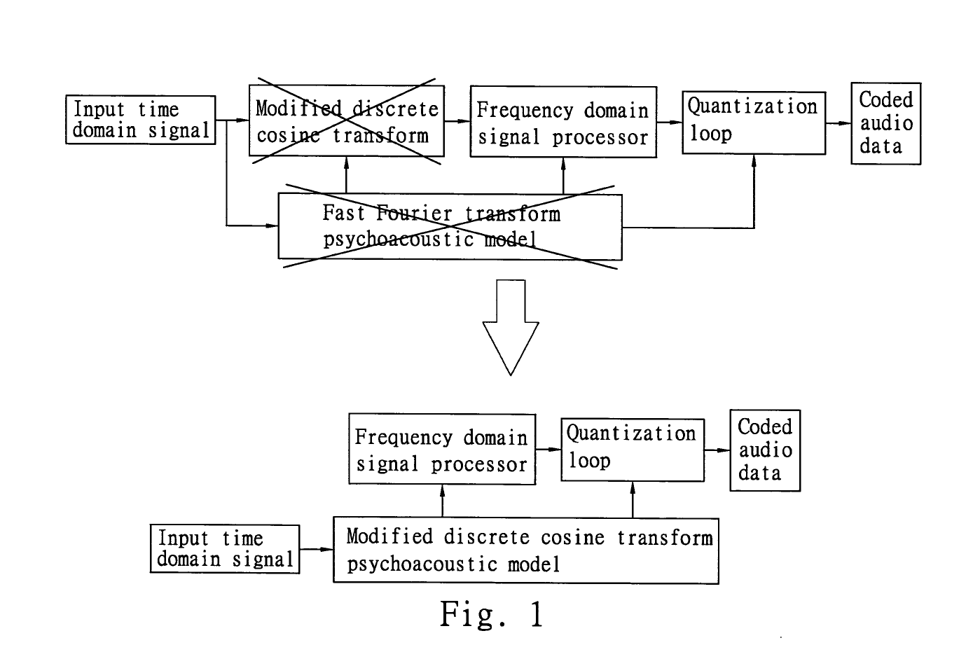

Referring to FIG. 1 for a schematic view of a corrected MDCT-based psychoacoustic model in accordance with the present invention, the present invention uses the corrected MDCT-based psychoacoustic model to substitute a fast Fourier transform based (FFT-based) psychoacoustic model of the original standard, so that the original modified discrete cosine transform (MDCT) of a filter bank uses the modified discrete cosine transform (MDCT) in the corrected MDCT-based psychoacoustic model for the computation to reduce the computational quantity. In addition, a block type is determined by adopting a frequency domain method to improve quality.

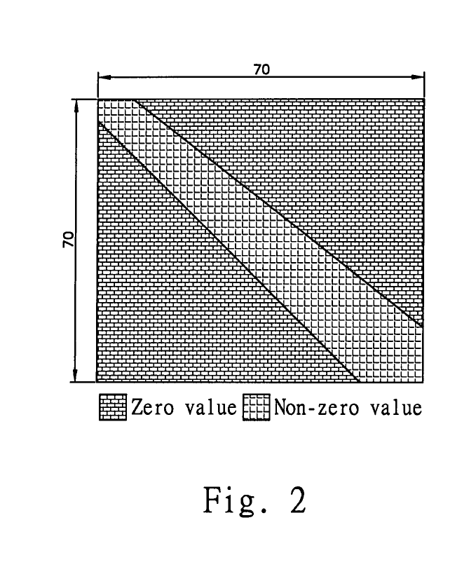

Referring to FIG. 2 for a schematic view of a distribution of coefficients of a spreading function in accordance with the present invention, the spreading function comes with a high complexity, and thus a simplified look-up table is used for storing the coefficients. Since the non-zero coefficients are distributed along diagonals, the present invention adopts a linear arrays method to store the non-zero coefficients, and this method not only reduces the computational quantity, but also reduce the size of the table.

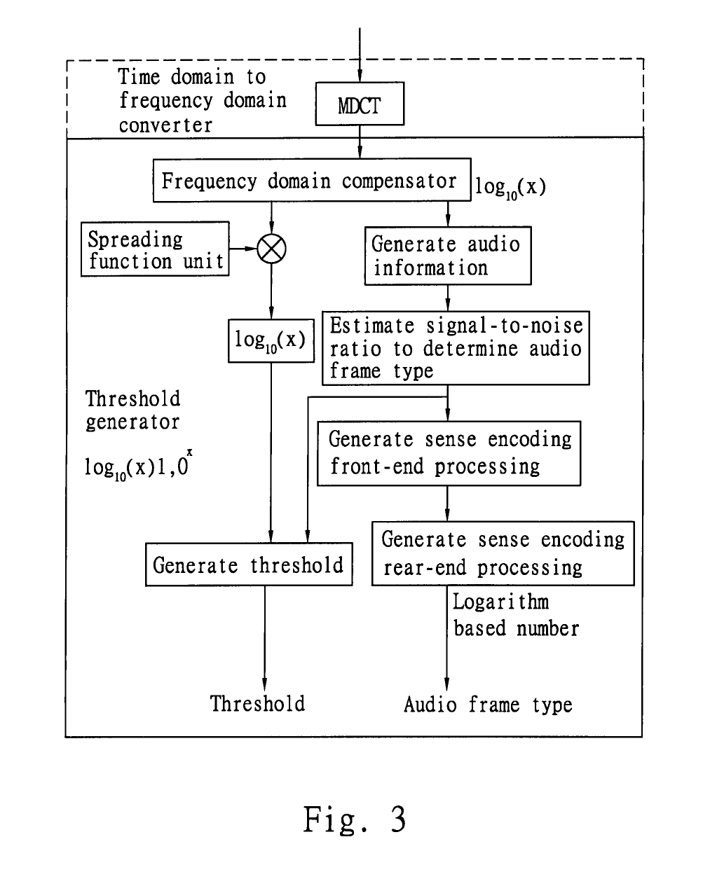

Referring to FIG. 3 for a schematic view of a logarithmic corrected MDCT-based psychoacoustic model algorithm in accordance with the present invention, only logarithm, exponential and division are remained in a complicated mathematical formula in the corrected modified discrete cosine transform (MDCT-based) psychoacoustic model after the method as illustrated in FIGS. 1 and 2 is applied. To further simplify the complexity, the present invention further adds a logarithmic method to remove the division, so as to lower the overall complexity of the corrected modified discrete cosine transform (MDCT-based) psychoacoustic model algorithm.

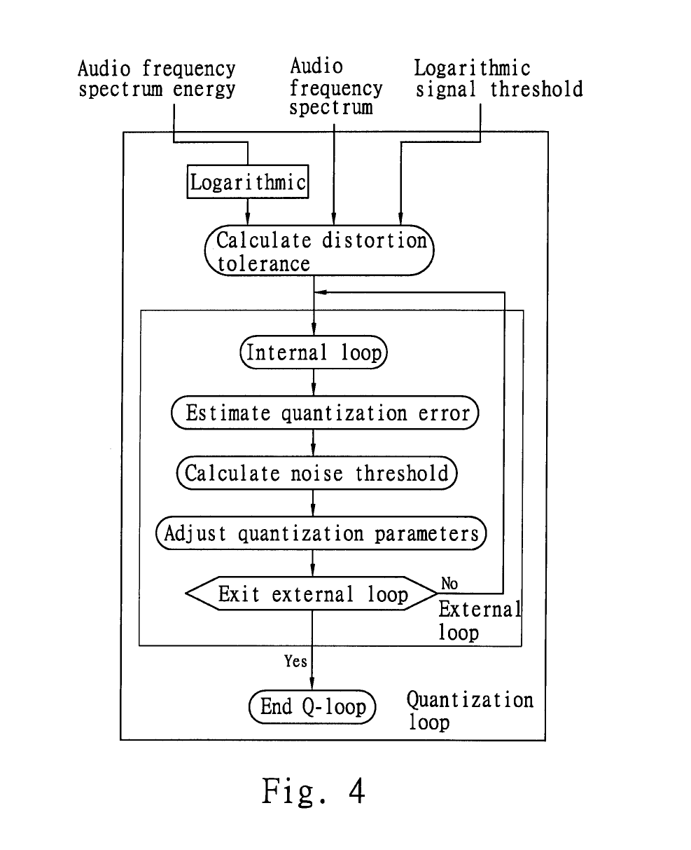

Referring to FIG. 4 for a logarithmic quantization loop algorithm in accordance with the present invention, after the portion of the quantization loop is added to the logarithm, a signal-to-mask ratio (signal-to-mask ratio, SMR) of an input portion is changed to a logarithmic signal-to-mask ratio (SMR), so that the corrected MDCT-based psychoacoustic model can use the logarithmic signal-to-mask ratio (SMR) as an output method, so as to skip the computational quantity of one exponent.

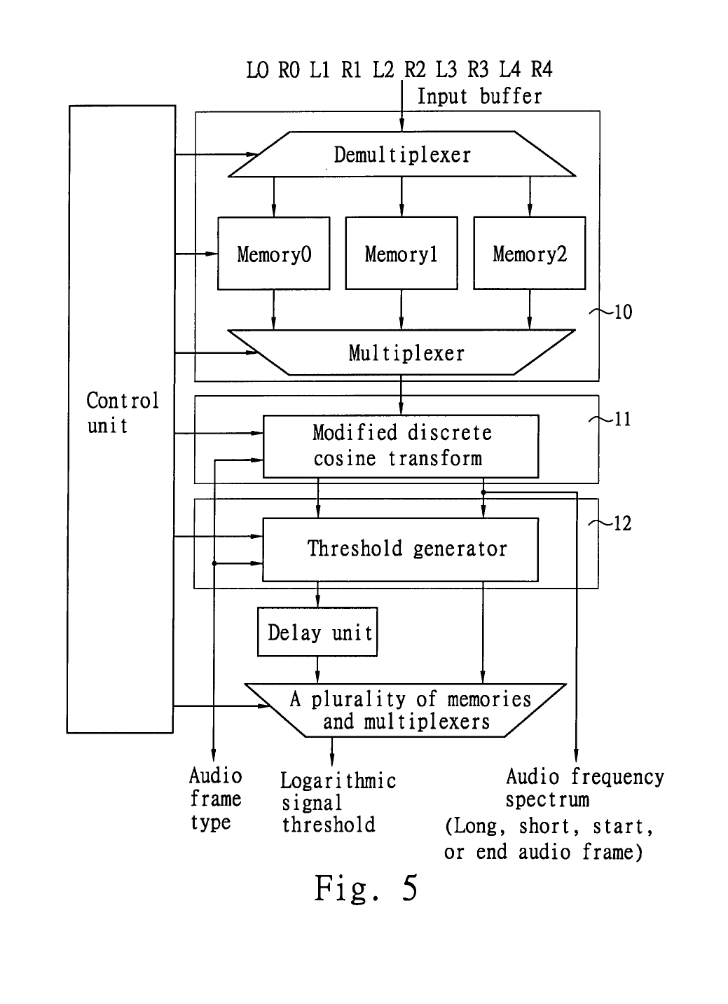

Referring to FIG. 5 for a schematic view of a structure of a whole psychoacoustic model in accordance with the present invention, the apparatus of the present invention comprises an input buffer 10, a modified discrete cosine transform (MDCT) 11 and a threshold generator 12, wherein the input buffer 10 is provided for storing information of a left audio channel and a right audio channel in an audio frame, and transmitting the information to the modified discrete cosine transform 11, and converting a time domain data into a frequency domain data, and then transmitting the frequency domain data to the threshold generator 12 for calculating the threshold of acoustic energy.

The input buffer 10 includes an input data (such as L0, R0 . . . ), a demultiplexer (DMUX), a plurality of memories (M0, M1, M2) and a multiplexer (MUX), wherein the L0, R0 . . . indicate a left audio channel audio frame 0, a right audio channel audio frame 0, . . . respectively, and this invention adopts three 1024×16 bit memories (M0, M1, M2) for storing data. Finally, the demultiplexer (DMUX) reads data from the memories (M0, M1, M2).

The modified discrete cosine transform (MDCT) 11 uses a fast Fourier transform (FFT) method for a frequency spectrum transformation, and achieves the frequency spectra of four audio frame types (such as long audio frame, short audio frame, start audio frame and stop audio frame).

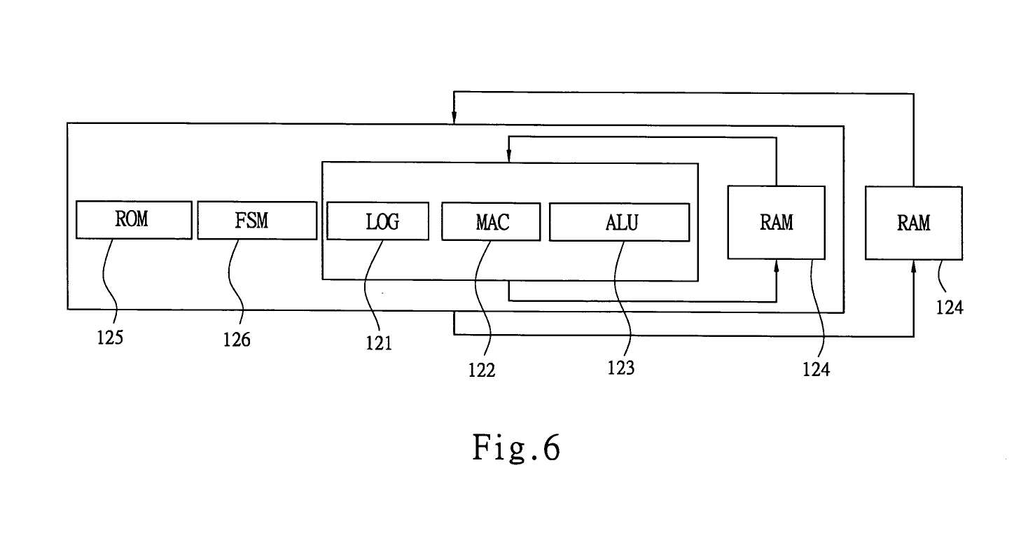

Referring to FIG. 6 for a schematic view of a structure of a threshold generator 12 in accordance with the present invention, the threshold generator 12 includes an internal block and an external block, wherein the internal block includes a logarithm unit (LOG) 121, a multiplication-and-accumulation) unit (MAC) 122 and an arithmetic logic unit (ALU) 123, and the external block includes a plurality of memory units such as a random access memory (RAM) 124, a read only memory (ROM) 125 and a finite state machine (FSM) 126 for storing coefficients.

Therefore, the method and apparatus of the present invention are useful, and the algorithm of the invention uses the corrected MDCT-based psychoacoustic model (PAM), a simplified look-up table used for a spreading function, and a logarithm based data for the computation to reduce the computational quantity and the complicated operators, and proposes to use a logarithm base quantization loop (Q Loop) for the computation to reduce the complicated operation (power of tens) required by the calibration conversion and simplify the multiplication and division in the quantization loop (Q Loop). The traditional programmable method takes weeks to complete the logarithmic operation, but the present invention adopts a pipelining modified discrete cosine transform (MDCT) and a digital signal processing like (DSP-like) data stream to compute the entire psychoacoustic model (PAM). Due to the low complexity, the invention can achieve a real-time playback effect at a sampling frequency of 44.1 KHz and an operating frequency of 20 MHz, and thus the method of the invention can be applied to a general portable device (such as a mobile phone, a walkman, and a flask disk, etc) to improve its practicability significantly.

The method and the apparatus of the present invention are novel. Unlike a prior art MDCT-based psychoacoustic model that selects a block type from a time domain and cannot maintain good quality, the present invention keeps the advantages of a MDCT-based psychoacoustic model without sacrificing quality by using a corrected MDCT-based psychoacoustic model, and a frequency domain method instead of a time domain method for the block selection. In addition, the invention uses a table to reduce the computational quantity of a spreading function. Analyses show that the non-zero coefficients appear at diagonals, and thus the invention adopts a linear arrays method to store the coefficient. Such arrangement not only avoids the computation of the spreading function, but also reduces the size of the look-up table. These characteristics of the invention are definitely different from the prior art.

The method and the apparatus of the present invention come with an inventive advancement, since the apparatus with the aforementioned two features can simplify the computational complexity while maintaining quality, and achieve a real-time playback effect by a low operating frequency. Compared with the prior art, the present invention is more applicable to a general handheld device (such as a mobile phone, a walkman, and a flash disk, etc), and thus the invention complies with the requirements of a patent invention.

While the invention has been described by means of a specific embodiment, numerous modifications and variations could be made thereto by those skilled in the art without departing from the scope and spirit of the invention set forth in the claims.

What is claimed is:

1. A method of a low-complexity psychoacoustic model applicable for advanced audio coding encoders, comprising the steps of:
using a corrected modified discrete cosine transform based (MDCT-based) psychoacoustic model to substitute a modified discrete cosine transform (MDCT) and a filter bank used in an entire advanced audio coding (AAC) standard and skip a fast Fourier transform (FFT) computation, and using a simplified look-up table to store coefficients of a spreading function in the corrected modified discrete cosine transform based (MDCT-based) psychoacoustic model algorithm;
using a logarithm based logarithmic method to perform a computation of the corrected modified discrete cosine transform based (MDCT-based) psychoacoustic model, so as to reduce a computational complexity; and
using a logarithm based logarithmic method to perform a computation of a quantization loop, so as to reduce a computational quantity of the corrected modified discrete cosine transform based (MDCT-based) psychoacoustic model.

2. The method of a low-complexity psychoacoustic model applicable for advanced audio coding encoders as recited in claim 1, wherein the corrected modified discrete cosine transform based (MDCT-based) psychoacoustic model substitutes an original standard based on a fast Fourier transform based (FFT-based) psychoacoustic model, and a block type is determined and selected by a frequency domain method.

3. The method of a low-complexity psychoacoustic model applicable for advanced audio coding encoders as recited in claim 2, wherein the spreading function includes coefficients with a high complexity, and non-zero coefficients are distributed along diagonals, and thus a linear arrays method of a simplified look-up table is used for storing the non-zero coefficients.

4. The method of a low-complexity psychoacoustic model applicable for advanced audio coding encoders as recited in claim 3, further comprising the steps of adding a logarithmic method to further simplify a complicated mathematical formula in the corrected modified discrete cosine transform based (MDCT-based) psychoacoustic model to remove the addition, so as to lower the complexity of the overall corrected modified discrete cosine transform based (MDCT-based) psychoacoustic model algorithm.

5. The method of a low-complexity psychoacoustic model applicable for advanced audio coding encoders as recited in claim 4, wherein after the portion of the quantization loop is added to the logarithm, a signal-to-mask ratio (SMR) of the input portion is changed into a logarithmic signal-to-mask ratio (SMR), such that the corrected MDCT-based psychoacoustic model uses the logarithmic signal-to-mask ratio (SMR) as an output method, such that the computational quantity of one exponent can be skipped.

6. An apparatus of a low-complexity psychoacoustic model applicable for advanced audio coding encoders, comprising:
an input buffer, for storing information of a left audio channel and a right audio channel of an audio frame;
a modified discrete cosine transform (MDCT), for receiving information transmitted from the input buffer to convert a time domain data into a frequency domain data;
a threshold generator, for receiving a frequency spectrum transmitted from the modified discrete cosine transform (MDCT) and using the received frequency spectrum to calculate the threshold of acoustic energy.

7. The apparatus of a low-complexity psychoacoustic model applicable for advanced audio coding encoders as recited in claim 6, wherein the input buffer includes an input data, a demultiplexer (DMUX), a plurality of memories and a multiplexer (MUX).

8. The apparatus of a low-complexity psychoacoustic model applicable for advanced audio coding encoders as recited in claim 6, wherein the modified discrete cosine transform (MDCT) performs a frequency spectrum transformation by a fast Fourier transform (FFT) method to achieve a plurality of types of audio frame frequency spectra.

9. The apparatus of a low-complexity psychoacoustic model applicable for advanced audio coding encoders as recited in claim 6, wherein the threshold generator includes an internal block and an external block, and the internal block includes a logarithm unit, a multiplication-and-accumulation unit and an arithmetic logic unit, and the external block includes a plurality of memory units.
